(19) United States
(12) Patent Application Publication
(10) Pub. No.: US 2007/0104376 A1
(43) Pub. Date: May 10, 2007

(54) Apparatus and method of recognizing characters contained in image

(75) Inventors: Cheolkon Jung, Suwon-si (KR); Jiyeun Kim, Seoul (KR); Youngsu Moon, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/592,116

(22) Filed: Nov. 3, 2006

(30) Foreign Application Priority Data
Nov. 4, 2005 (KR) 10-2005-105583

(51) Int. Cl. G06K 9/72

(52) U.S. Cl. 382/229; 382/185

(57) ABSTRACT

An apparatus for recognizing characters contained in an image includes: a character string segmentation unit segmenting character strings of the characters contained in the image into a variety of combinations; a character string determination unit determining the character string having a highest geometrical character goodness of fit and a highest character recognition grade among the character strings segmented into a variety of combinations; and a character string correction unit correcting the determined character string based on a language model. It is possible to effectively recognize characters even for character strings having a relatively thick font or a relatively narrow spacing between characters or containing special characters.

### CROSS-REFERENCE TO RELATED APPLICATIONS

This application claims the benefit of Korean Patent Application No. 10-2005-0105583, filed on Nov. 4, 2005, in the Korean Intellectual Property Office, the disclosure of which is incorporated herein in its entirety by reference.

### BACKGROUND OF THE INVENTION

1. Field of the Invention

The present invention relates to a technique for recognizing characters such as characters contained in an image, and more particularly, to an apparatus and method of recognizing characters contained in an image, by which characters can be effectively recognized even for character strings having a relatively thick font or a relatively narrow spacing between characters or containing special characters.

2. Description of the Related Art

Since characters contained in an image provide important information, importance of character recognition has been increasing. For example, the character recognition can be used for recognizing meanings of characters contained in still images such as a business card image or moving pictures for news, sports, and the like.

Conventionally, grapheme based recognition or syllable based recognition has been used as a method of recognizing characters contained in an image.

However, there is much need for improvement in conventional techniques for correcting erroneously segmented characters when a process for segmenting character strings contained in an image outputs erroneous results. In addition, there is a problem that a probability of erroneously recognizing the character strings having a relatively thick font and a relatively narrow spacing between characters or containing special characters is high.

### SUMMARY OF THE INVENTION

The present invention provides an apparatus and method of effectively recognizing characters contained in an image.

According to an aspect of the present invention, there is provided an apparatus for recognizing characters contained in an image, including: a character string segmentation unit segmenting character strings of the characters contained in the image into a variety of combinations; a character string determination unit determining the character string having a highest geometrical character goodness of fit and a highest character recognition grade among the character strings segmented into a variety of combinations; and a character string correction unit correcting the determined character string based on a language model.

According to another aspect of the present invention, there is provided a method of recognizing characters contained in an image, including: (a) segmenting character strings of the characters contained in the image into a variety of combinations; (b) determining the character string having a highest geometrical character goodness of fit and a highest character recognition grade among the character strings segmented into a variety of combinations; and (c) correcting the determined character string based on a language model.

Additional aspects and/or advantages of the invention will be set forth in part in the description which follows and, in part, will be apparent from the description, or may be learned by practice of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating an apparatus for recognizing characters contained in an image according to an exemplary embodiment of the present invention;

FIG. 2 illustrates special characters arranged in upper and lower halves with respect to a center line according to an exemplary embodiment of the present invention;

FIG. 3, parts (a) and (b), illustrate special character templates for parentheses according to an exemplary embodiment of the present invention;

FIG. 4, parts (a) through (e), illustrate examples of segmenting a Korean character string contained in an image into a variety of combinations in a character string segmentation unit;

FIG. 5 is a block diagram for describing the character string determination unit shown in FIG. 1 according to an exemplary embodiment of the present invention;

FIG. 6 is a block diagram for describing the character recognition grade calculation unit shown in FIG. 5 according to an exemplary embodiment of the present invention;

FIG. 7, parts (a) through (f), illustrate six classifications of Korean character classified according to an exemplary embodiment of the present invention;

FIG. 8 shows lattice intervals in a 6×6 mesh established based on a histogram of brightness density of a segmented character according to an exemplary embodiment of the present invention;

FIG. 9 shows the numbers of directional angles belonging to the same directional angle range in a lattice;

FIG. 10, parts (a) and (b), show images normalized for a negative sign “−” and a numeral “2”;

FIG. 11 is a flowchart describing a method of recognizing characters contained in an image according to an exemplary embodiment of the present invention;

FIG. 12 is a flowchart describing operation 504 shown in FIG. 11 according to an exemplary embodiment of the present invention; and

FIG. 13 is a flowchart describing operation 604 shown in FIG. 12 according to an exemplary embodiment of the present invention.

### DETAILED DESCRIPTION OF THE PREFERRED EMBODIMENTS

The attached drawings for illustrating exemplary embodiments of the present invention are referred to in order to gain a sufficient understanding of the present invention, the merits thereof, and the objectives accomplished by the implementation of the present invention.

An apparatus for recognizing characters contained in an image according to the present invention will now be described in detail with reference to the accompanying drawings, wherein like reference numerals refer to the like elements throughout.

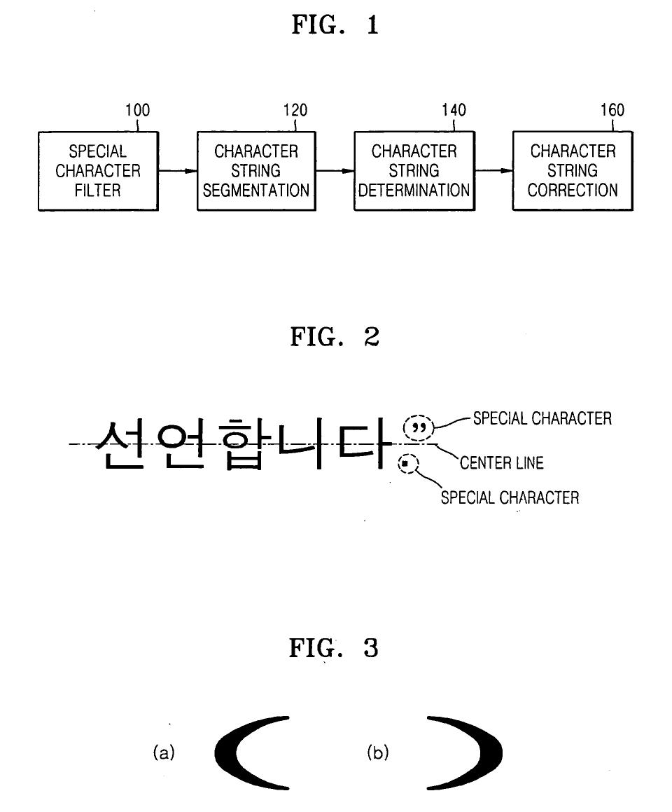

FIG. 1 is a block diagram illustrating an apparatus for recognizing characters contained in an image according to an exemplary embodiment of the present invention. The apparatus for recognizing characters includes a special character filter unit 100, a character string segmentation unit 120, a character string determination unit 140, and a character string correction unit 160.

The special character filter unit 100 filters special characters from the characters contained in an image and outputs the filtering result to the character string segmentation unit 120.

The special character filter unit 100 detects special characters arranged in upper and lower halves with respect to a center line of the characters contained in an image.

FIG. 2 illustrates special characters arranged on upper and lower halves with respect to a center line according to an exemplary embodiment of the present invention. As shown in FIG. 2, the special character filter unit 100 filters special characters [″] and [.] arranged on upper and lower halves with respect to the center line of the characters, respectively. In addition to the aforementioned special characters, the special character filter unit 100 may filter various special characters, such as [′] or [,], arranged on upper and lower halves with respect to the center line of the characters.

Furthermore, the special character filter unit 100 detects special characters by using a special character template.

FIG. 3, parts (a) and (b), illustrate special character templates for parentheses according to an exemplary embodiment of the present invention. FIG. 3, parts (a) and (b), show parenthesis templates for left and right parentheses, respectively. Such a parenthesis template is established by using an average model for various sizes and shapes of parentheses as a template. For example, the special character filter unit 100 may detect whether or not the parentheses are contained in a character string while the characters contained in an image are scanned by using the parenthesis templates shown in FIG. 3, parts (a) and (b). The detected parentheses are filtered.

The character string segmentation unit 120 segments the character string filtered in the special character filter unit 100 into a variety of combinations, and outputs the segmentation result to the character string determination unit 140.

The character string segmentation unit 120 segments the character string contained in an image by using a nonlinear cutting path method. The nonlinear cutting path is a method of finding and cutting a path obtaining a highest point among the paths having points by using a dynamic programming.

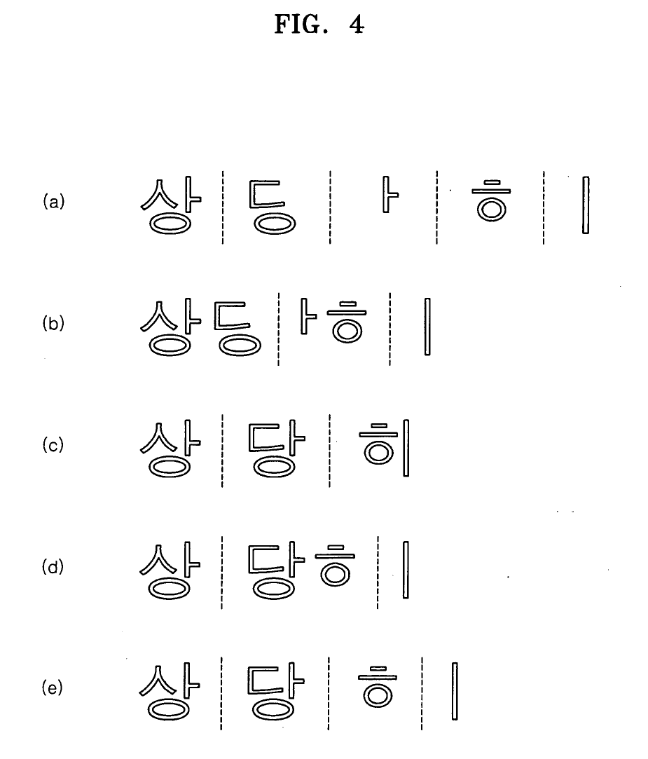

FIG. 4, parts (a) through (e), illustrate examples of segmenting a Korean character string contained in an image into a variety of combinations in a character string segmentation unit. As shown in FIG. 4, the character string segmentation unit 120 can segment the character string into a variety of combinations.

The character string determination unit 140 determines a character string having a highest geometrical character goodness of fit and a highest character recognition grade among the character strings segmented into a variety of combinations, and outputs the determined result to the character string correction unit 160.

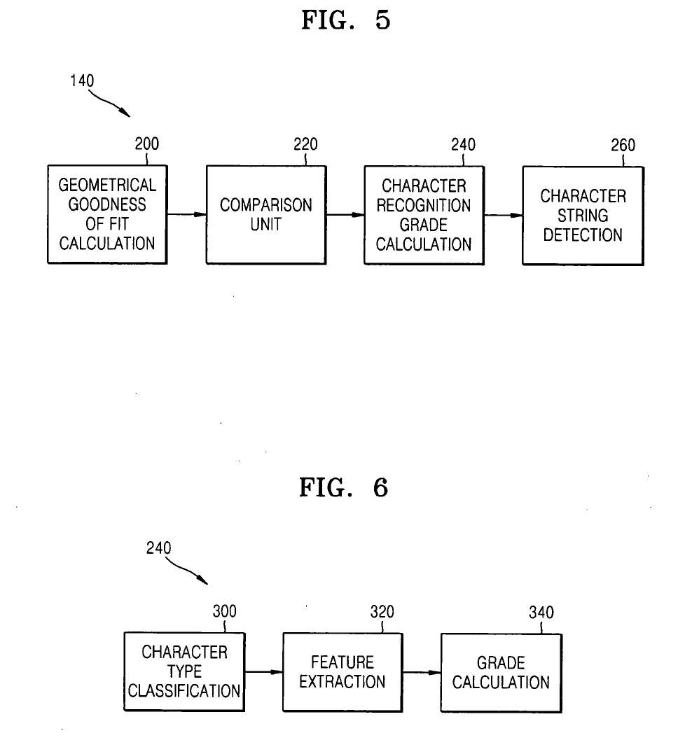

FIG. 5 is a block diagram for describing the character string determination unit shown in FIG. 1 according to an exemplary embodiment of the present invention. The character string determination unit 140 includes a geometrical goodness of fit calculation unit 200, a comparison unit 220, a character recognition grade calculation unit 240, and a character string detection unit 260.

The geometrical goodness of fit calculation unit 200 calculates the geometrical character goodness of fit for the segmented character string, and outputs the calculation result to the comparison unit 220. The geometrical character goodness of fit is obtained by quantizing the geometrical features of the segmented characters, such as how much the widths and heights of characters substantially match, or how much distances between characters substantially match. Therefore, the geometrical goodness of fit calculation unit 200 calculates the geometrical character goodness of fit based on width variations and squarenesses of the segmented characters in the segmented character string and distances between the segmented characters.

The width variation may be obtained by using Equation 1 as follows:
Width Variation=min(Wᵢ₋₁, Wᵢ)/max(Wᵢ₋₁, Wᵢ), (1)
where, min(Wᵢ₋₁, Wᵢ) denotes a smaller one between the width Wᵢ of the segmented character i and the width Wᵢ₋₁ of the segmented character i-1, and max(Wᵢ₋₁, Wᵢ) denotes a larger one between the width Wᵢ of the segmented character i and the width Wᵢ₋₁ of the segmented character i-1.

The squareness can be obtained by using Equation 2 as follows:
Squareness=min(Wᵢ, Hᵢ)/max(Wᵢ, Hᵢ), (2)
where, min(Wᵢ, Hᵢ) denotes a smaller one between the width Wᵢ and the height Hᵢ of the segmented character i, and max(Wᵢ, Hᵢ) denotes a larger one between the width Wᵢ and the height Hᵢ of the segmented character i.

Meanwhile, the distance between characters as another example of the geometrical character goodness of fit means a separation distance between the segmented characters.

The geometrical goodness of fit calculation unit 200 calculates an average of the width variations, an average of the squarenesses, and an average of the distances for each of the aforementioned characters, and then obtains the geometrical character goodness of fit by summing the calculated averages.

The comparison unit 220 compares the geometrical character goodness of fit obtained in the geometrical goodness of fit calculation unit 200 with a predetermined reference value, and output the comparison result to the character recognition grade calculation unit 240. The predetermined reference value denotes a minimum value for satisfying the geometrical character goodness of fit for the segmented character.

The character recognition grade calculation unit 240 calculates the character recognition grade for the character string, having the geometrical goodness of fit exceeding the predetermined reference value, in response to the comparison result from the comparison unit 220.

FIG. 6 is a block diagram for describing the character recognition grade calculation unit shown in FIG. 5 according to an exemplary embodiment of the present invention. The character recognition grade calculation unit 240 includes a character type classification unit 300, a feature extraction unit 320, and a grade calculation unit 340.

The character type classification unit 300 classifies each of the segmented characters in the character string, having the geometrical goodness of fit exceeding the predetermined reference value, into corresponding character types and outputs the classification result to the feature detection unit 320.

The character type classification unit 300 divides the character type into a total of seven types, including six types for Korean characters and one type for English characters, numerals, and special characters, and classifies the segmented character into one of the seven character types.

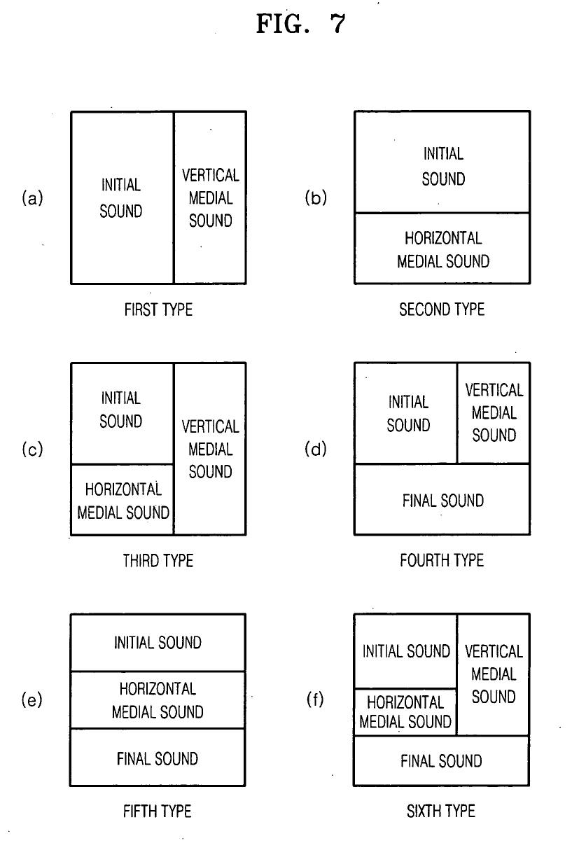

FIG. 7, parts (a) through (f), illustrate six types for Korean characters according to an exemplary embodiment of the present invention. As shown in FIG. 7, parts (a) through (f), FIG. 7, part (a), shows a first type corresponding to, for example, a Korean character [symbol] FIG. 7, part (b), shows a second type corresponding to, for example, a Korean character [symbol] FIG. 7, part (c), shows a third type corresponding to, for example, a Korean character [symbol] FIG. 7, part (d), shows a fourth type corresponding to, for example, a Korean character [symbol] FIG. 7, part (e), shows a fifth type corresponding to, for example, a Korean character [symbol] and FIG. 7, part (f), shows a sixth type corresponding to, for example, a Korean character

[symbol]

If the character corresponds to a Korean character, the character type classification unit 300 classifies the character into one of the six types shown in FIG. 7. If the character corresponds to one of English character, numerals, and special characters, the character type classification unit 300 classifies the character into the remaining one type.

The feature extraction unit 320 extracts the feature of the segmented character based on the character type classifications of the character type classification unit 300, and outputs the extraction result to the degree calculation unit 340.

The feature extraction unit 320 detects directional angles for each pixel of the segmented character.

The feature extraction unit 320 divides the segmented character into a mesh, and calculates the number of the directional angles belonging to the same directional angle ranges in the lattice of the divided mesh to extract the feature value corresponding to a vector value.

If the segmented character corresponds to a Korean character, the feature extraction unit 320 establishes each lattice intervals in the mesh based on the brightness density of the segmented character.

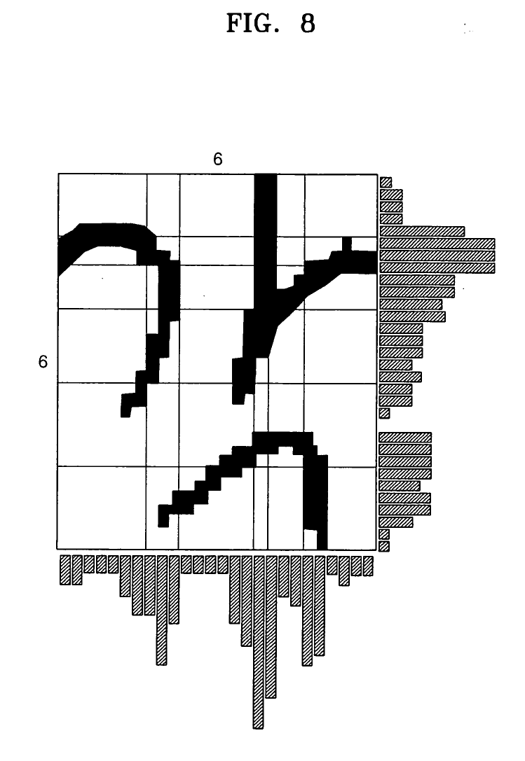

FIG. 8 shows lattice intervals in a 6×6 mesh established based on a histogram of brightness density of the segmented character according to an exemplary embodiment of the present invention. Referring to FIG. 8, the brightness values of a Korean character [symbol] are vertically and horizontally projected to produce a histogram. The lattice interval of the mesh is narrow in the portions where the height of the bar in the histogram is large, while the lattice interval of the mesh is wide in the portions where the height of the bar in the histogram is small. In this way, the feature extraction unit 320 forms the narrow lattice interval in the mesh for the portions where the brightness density of the segmented character is large, but forms the wide lattice interval in the mesh for the portions where the brightness density of the segmented character is small.

For example, supposing that a directional angle of 360 degrees is divided into eight portions, the feature extraction unit 320 calculates the number of the directional angles belonging to the same directional angle range among the directional angle ranges divided into eight portions in one lattice of the mesh shown in FIG. 8.

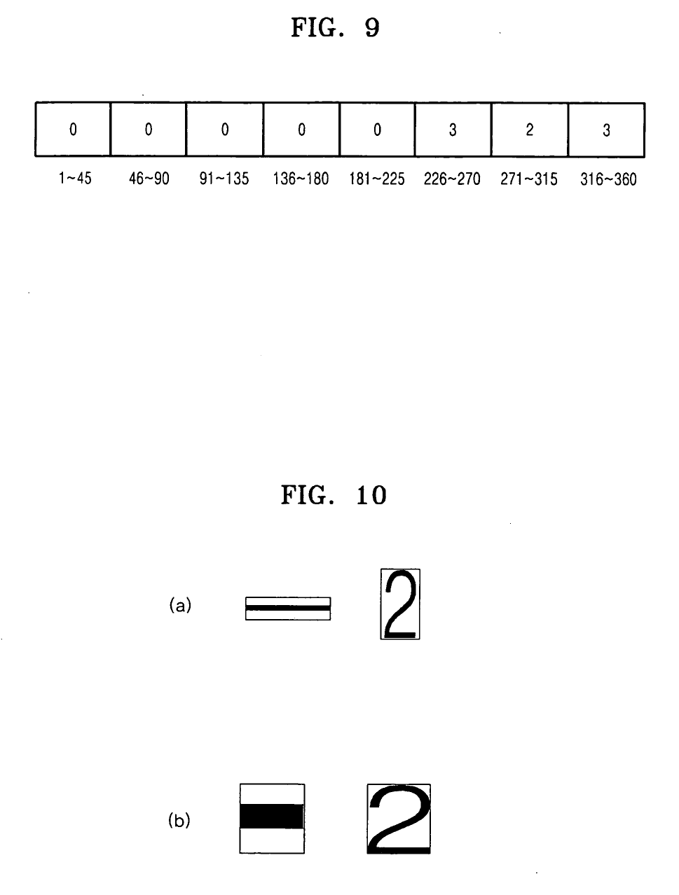

FIG. 9 shows the numbers of directional angles belonging to the same directional angle range in a lattice. As shown in FIG. 9, the number for the eight directional angle ranges in a lattice is calculated, and these numbers for each lattice are gathered to extract a feature value corresponding to a vector value.

If the segmented character corresponds to one of English character, numerals, and special characters, the feature extraction unit 320 normalizes the height and the width of the segmented character and extracts the feature value of the normalized character.

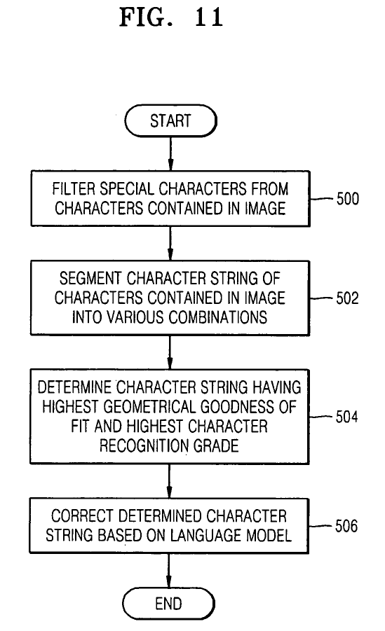

FIG. 10, parts (a) and (b), show images normalized for a negative sign “−” and a numeral “2”. In other words, FIG. 10, part (a), shows an original image of the negative sign “−” and numeral “2”, and FIG. 10, part(b), shows a normalized image obtained by normalizing the width and the height of the original image. For example, the feature extraction unit 320 normalizes the width and the height of the original image of the negative sign “−” and numeral “2”, and extracts the feature value of the normalized negative sign “−” and numeral “2”.

The grade calculation unit 340 calculates the character recognition grade by using the feature value extracted in the feature extraction unit 320 and a character statistic model.

The similarity between the extracted feature value and the character statistic model is obtained by using a Mahalanobis distance. The Mahalanobis distance is a distance obtained by considering distribution or correlation of the feature values.

The Mahalanobis distance for calculating the similarity between the extracted feature value and the character statistic model is obtained by using Equation 3 as follows:
rⱼ=\sqrt{(x−μⱼ)^{T}Σ⁻¹(x−μⱼ)}, (3)
where, the vector value x denotes the feature value, and the vector value μⱼ denotes an average of the character statistic model.

If the expression of the Mahalanobis distance as a probability is called a normal posterior conditional probability, the normal posterior conditional probability is obtained by using Equation 4 as follows:

$$P ( {ω}_{k} \text{\vert} x ) = \frac{p ( x \text{\vert} {ω}_{k} ) p ( {ω}_{k} )}{p ( x )} = \frac{exp ( - \frac{1}{2} ⨯ {r}_{k}^{2} )}{{\sum }_{i = 1}^{c} exp ( - \frac{1}{2} ⨯ {r}_{j}^{2} )} , \qquad ( 4 )$$

where, P(ωₖ|x) denotes the normal posterior conditional probability.

The grade calculation unit 340 calculates the character recognition grade by summing the normal posterior conditional probabilities for each segmented character.

The character string extraction unit 260 extracts one of the character strings, having a maximum value of a sum of the geometrical goodness of fit calculated in the geometrical goodness of fit calculation unit 200 and the character recognition grade calculated in the character recognition grade calculation unit 240.

The character string correction unit 160 corrects the character string determined in the character string determination unit 140 based on a language model. Each of the characters of the character string determined in the character string determination unit 140 has a preference of the character recognition grade. The character string correction unit 160 corrects the character string based on the preference of the character recognition degrees determined in the character string determination unit 140 and the language model.

A method of recognizing characters contained in an image according to the present invention will now be described in detail with reference to the accompanying drawings.

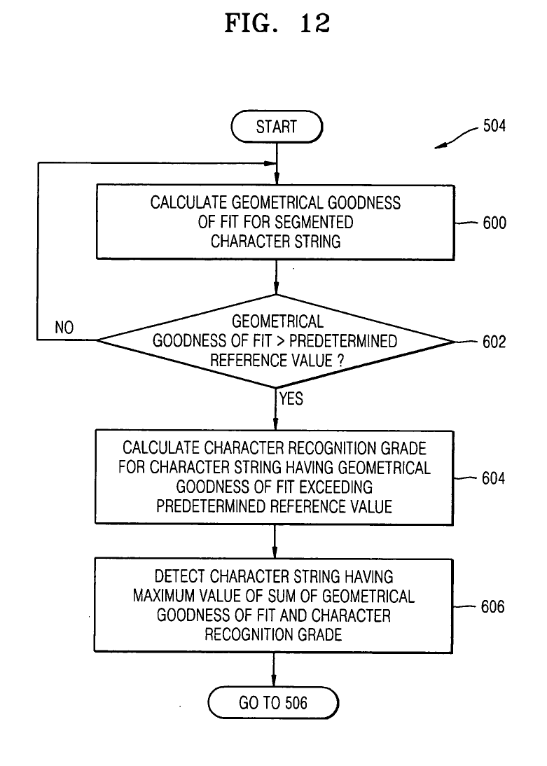

FIG. 11 is a flowchart describing a method of recognizing characters contained in an image according to an exemplary embodiment of the present invention.

First, special characters are filtered from the characters contained in an image (operation 500).

Operation 500 is characterized in that the special characters arranged on upper and lower halves with respect to the center line of the characters contained in an image are detected. As shown in FIG. 2, special characters [″] and [.] arranged on the upper and lower halves with respect to the center line of the characters are filtered. In addition to the aforementioned special characters, various special characters, such as [′] or [,], arranged on the upper and lower halves with respect to the center line of the characters may be filtered.

In addition, operation 500 is characterized in that special characters are detected by using a special character template. FIG. 3, parts (a) and (b), show parenthesis templates for left and right parentheses, respectively. Such a parenthesis template is established by using an average model for various sizes and shapes of parentheses as a template. Whether or not the parentheses are included in the character string can be detected while the characters contained in an image are scanned by using the parenthesis template shown in FIG. 3. The detected parentheses are filtered.

After operation 500, the character string of the characters contained in an image is segmented into a variety of combinations (operation 502). Specifically, the character string of the characters contained in an image is segmented by using a nonlinear cutting path method.

As shown in FIG. 4, the character strings can be segmented into a variety of combinations.

After operation 502, the character string having a highest geometrical character goodness of fit and a highest character recognition grade among the character strings segmented into a variety of combinations, is determined (operation 504).

FIG. 12 is a flowchart for describing operation 504 shown in FIG. 11 according to an exemplary embodiment of the present invention.

The geometrical goodness of fit for the segmented character string is calculated (operation 600).

The geometrical character goodness of fit is calculated based on width variations and squarenesses of the segmented characters in the segmented character string and distances between the segmented characters. The width variation can be obtained by using Equation 1, and the squareness of the character string can be obtained by using Equation 2 as mentioned above.

The geometrical character goodness of fit is obtained by calculating an average of the width variations, an average of the squarenesses, and an average of the distances for each of the aforementioned characters and then summing the calculated averages.

After operation 600, the obtained geometrical character goodness of fit is compared with a predetermined reference value (operation 602). The predetermined reference value denotes a minimum value for satisfying the geometrical character goodness of fit for the segmented character.

If the obtained geometrical character goodness of fit exceeds the predetermined reference value, the character recognition grade for the character string having the geometrical character goodness of fit exceeding the predetermined reference value is calculated (operation 604).

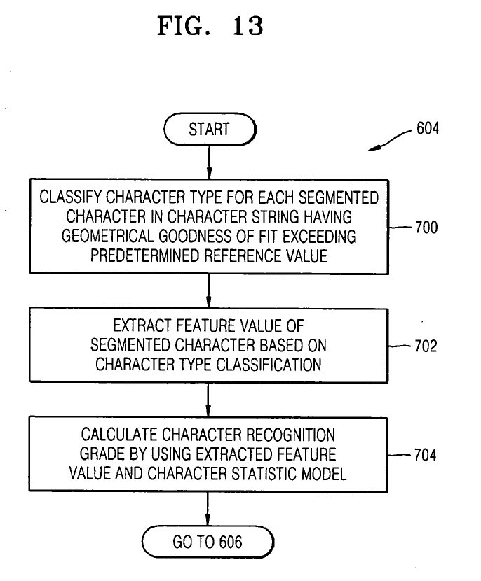

FIG. 13 is a flowchart for describing operation 604 shown in FIG. 12 according to an exemplary embodiment of the present invention.

Each of the segmented characters in the character string, having the geometrical goodness of fit exceeding the predetermined reference value, is classified into character types (operation 700).

The character type is divided into a total of seven types, including six types for Korean character and one type for English character, numerals, and special characters, and the segmented character is classified into one of the seven character types.

After operation 700, the feature value of the segmented character is extracted based on the character type classifications (operation 702).

First, directional angles for each pixel of the segmented character are detected. Then, the segmented character is divided into a mesh, and the number of the directional angles belonging to the same directional angle ranges in the lattice of the divided mesh is calculated to extract the feature value corresponding to a vector value.

If the segmented character corresponds to a Korean character, the lattice intervals in the mesh are established based on the brightness density of the segmented character.

As shown in FIG. 8, the wide lattice interval in the mesh is formed for the portions where the brightness density of the segmented character is large, but the narrow lattice interval in the mesh is formed for the portions where the brightness density of the segmented character is small.

For example, supposing that a directional angle of 360 degrees is divided into eight portions, the number of the directional angles belonging to the same directional angle range among the directional angle ranges divided into eight portions in one lattice of the mesh shown in FIG. 8, is calculated. As shown in FIG. 9, the number for the eight directional angle ranges in a lattice is calculated, and these numbers for each lattice are gathered to extract the feature value corresponding to a vector value.

Meanwhile, if the segmented character corresponds to one of English characters, numerals, and special characters, the height and the width of the segmented character are normalized, and the feature value of the normalized character is calculated.

After operation 702, the character recognition degree is calculated by using the extracted feature value and the character statistic model (operation 704).

The similarity between the extracted feature value and the character statistic model is obtained by using a Mahalanobis distance. The Mahalanobis distance is a distance obtained by considering distribution or correlation of the feature values. The Mahalanobis distance for calculating the similarity between the extracted feature value and the character statistic model is obtained by using Equation 3 as mentioned above.

If the expression of the Mahalanobis distance as a probability is called a normal posterior conditional probability, the normal posterior conditional probability is obtained by using Equation 4 as mentioned above.

The character recognition degree is calculated by summing the normal posterior conditional probabilities for each segmented character.

After operation 604, the character string having a maximum value of a sum of the calculated geometrical goodness of fit and the calculated character recognition grade, is extracted (operation 606).

After operation 504, the determined character string is corrected based on a language model (operation 506). Each of the characters of the character string determined in operation 504 has a preference of the character recognition grade. The character string is corrected based on the preference of the character recognition grades calculated in operation 504 and the language model.

According to the present invention, it is possible to effectively recognize characters even for character strings having a relatively thick font or a relatively narrow spacing between characters or containing special characters.

The embodiments of the present invention can be written as computer codes/instructions/programs and can be implemented in general-use digital computers that execute the computer codes/instructions/programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet). The computer readable recording medium can also be distributed over network coupled computer systems so that the computer readable codes/instructions/programs are stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those skilled in the art that various changes in form and details may be made therein without departing from the spirit and scope of the invention as defined by the appended claims. Therefore, the scope of the invention is defined by the appended claims, and all differences within the scope will be construed as being included in the present invention.

What is claimed is:

1. An apparatus for recognizing characters contained in an image, comprising:
a character string segmentation unit segmenting character strings of the characters contained in the image into a variety of combinations;
a character string determination unit determining the character string having a highest geometrical character goodness of fit and a highest character recognition grade among the character strings segmented into a variety of combinations; and
a character string correction unit correcting the determined character string based on a language model.

2. The apparatus of claim 1, wherein the character string segmentation unit segments the character strings of the characters contained in the image by using a nonlinear cutting math method.

3. The apparatus of claim 1, wherein the character string determination unit comprises:
a geometrical goodness of fit calculation unit calculating the geometrical character goodness of fit for the segmented character string;
a comparison unit comparing the calculated geometrical character goodness of fit with a predetermined reference value;
a character recognition grade calculation unit calculating the character recognition grade for the character string having the geometrical character goodness of fit exceeding the reference value in response to the comparison result of the comparison unit; and
a character string detection unit detecting the character string having a maximum value of a sum of the calculated geometrical character goodness of fit and the calculated character recognition grade.

4. The apparatus of claim 3, wherein the geometrical goodness of fit calculation unit calculates the geometrical character goodness of fit based on width variations of the segmented characters in the segmented character string, squarenesses of the segmented characters, and distances between the segmented characters.

5. The apparatus of claim 3, wherein the character recognition grade calculation unit comprises:
a character type classification unit classifying each of the segmented characters in the character string having the geometrical character goodness of fit exceeding the reference value into a character type;
a feature extraction unit extracting a feature value of the segmented character based on the character type classification; and
a grade calculation unit calculating the character recognition grade by using the extracted feature value and a character statistic model.

6. The apparatus of claim 5, wherein the character type classification unit divides the character type into a total of seven types, including six types for Korean character and one type for English characters, numerals, and special characters, and classifies the segmented character into one of the seven character types.

7. The apparatus of claim 5, wherein the feature extraction unit detects directional angles for each pixel of the segmented character, and calculates the number of the detected directional angles belonging to the same directional angle range in a lattice divided into a mesh of the segmented character to extract the feature value corresponding to a vector value.

8. The apparatus of claim 7, wherein the feature extraction unit establishes lattice intervals of the mesh based on brightness density of the segmented character if the segmented character corresponds to a Korean character.

9. The apparatus of claim 7, wherein the feature extraction unit normalizes a width and a height of the segmented character and extracts the feature value of the normalized character if the segmented character corresponds to one of English character, numerals, and special characters.

10. The apparatus of claim 5, wherein, a normal posterior conditional probability denotes an expression of a similarity between the extracted feature value and the character statistic model as a probability using a Mahalanobis distance, the grade calculation unit calculates the character recognition grade by summing the normal posterior conditional probabilities for each of the segmented characters of the segmented character string.

11. The apparatus of claim 1, further comprising a special character filter unit filtering special characters from the characters contained in the image.

12. The apparatus of claim 11, wherein the special character filter unit detects special characters arranged on upper and lower halves with respect to a center line of the characters contained in the image.

13. The apparatus of claim 11, wherein the special character filter unit detects the special characters by using a special character template.

14. A method of recognizing characters contained in an image, comprising:
(a) segmenting character strings of the characters contained in the image into a variety of combinations;
(b) determining the character string having a highest geometrical character goodness of fit and a highest character recognition grade among the character strings segmented into a variety of combinations; and
(c) correcting the determined character string based on a language model.

15. The method of claim 14, wherein the (a) is performed by using a nonlinear cutting path method.

16. The method of claim 14, wherein (b) comprises:
(b1) calculating the geometrical character goodness of fit for the segmented character string;
(b2) comparing the calculated geometrical character goodness of fit with a predetermined reference value;
(b3) calculating the character recognition grade for the character string having the geometrical character goodness of fit exceeding the predetermined reference value if the calculated geometrical character goodness of fit exceeds the predetermined reference value; and
(b4) detecting the character string having a maximum value of a sum of the calculated geometrical character goodness of fit and the calculated character recognition grade.

17. The method of claim 16, wherein (b1) comprises calculating the geometrical character goodness of fit based on width variations of the segmented characters in the segmented character strings, squarenesses of the segmented characters, and distances between the segmented characters.

18. The method of claim 16, wherein (b3) comprises:
(b31) classifying character types for each of the segmented characters in the character string having the geometrical character goodness of fit exceeding the predetermined reference value;
(b32) extracting a feature value of the segmented character based on the character type classifications; and
(b33) calculating the character recognition grade by using the extracted feature value and a character statistic model.

19. The method of claim 18, wherein (b31) comprises dividing the character type into a total of seven character types, including six types for Korean characters and one type for English characters, numerals, and special characters, and the segmented character is classified into one of the seven character types.

20. The method of claim 18, wherein (b32) comprises extracting the feature value corresponding to a vector value by detecting directional angles for each pixel of the segmented character and calculating the number of the detected directional angles belonging to the same directional angle range in a lattice of a mesh of the segmented character.

21. The method of claim 20, wherein (b32) comprises establishing the lattice intervals in the mesh based on brightness density of the segmented character if the segmented character corresponds to a Korean character.

22. The method of claim 20, wherein (b32) comprises:
normalizing the height and the width of the segmented character, and
calculating the feature value of the normalized character if the segmented character corresponds to one of English characters, numerals, and special characters.

23. The method of claim 18, wherein (b32) comprises if a normal posterior conditional probability denotes an expression of a similarity between the extracted feature value and the character statistic model as a probability using a Mahalanobis distance, the character recognition grade is calculated by summing the normal posterior conditional probabilities for each of the segmented characters of the segmented character string.

24. The method of claim 14, further comprising (d) filtering special characters from the characters contained in the image, wherein (a) is performed after (d).

25. The method of claim 24, wherein (d) comprises detecting the special characters arranged on upper and lower halves with respect to a center line of the characters contained in the image.

26. The method of claim 24, wherein (d) comprises detecting the special characters using a special character template.

27. A computer readable recording medium recording a program for executing the method of claim 14.
